(19) United States
(12) Patent Application Publication
(10) Pub. No.: US 2025/0118515 A1
(43) Pub. Date: Apr. 10, 2025

(54) CONTACTOR AND CONTROL METHOD THEREOF

(71) Applicant: Schneider Electric Industries SAS, Rueil-Malmaison (FR)

(72) Inventors: Yuanzhong Wang, Shanghai (CN); Xu Han, Shanghai (CN); Zhiping Huan, Shanghai (CN); Hao Zhuang, Shanghai (CN); Shaofan Li, Shanghai (CN); Kailiang Fu, Shanghai (CN); Juan Xie, Shanghai (CN)

(73) Assignee: Schneider Electric Industries SAS, Rueil-Malmaison (FR)

(21) Appl. No.: 18/795,294

(22) Filed: Aug. 6, 2024

(30) Foreign Application Priority Data
Oct. 10, 2023 (CN) 202311309732.4

(51) Int. Cl. H01H 47/00; H01H 47/22

(52) U.S. Cl. CPC H01H 47/002; H01H 47/22

(57) ABSTRACT

A contactor and a control method thereof are disclosed, the contactor including: an electromagnetic component; a static contact; a movable component including a connected movable contact, a first elastic part configured to generate an elastic force supporting the movable component and a driving part configured to produce an electromagnetic driving force through a magnetic field generated by the electromagnetic component; a sensor; and a controller configured to: in response to the sensor detecting that the driving part is displaced based on the electric repulsion force generated by the current flowing through the movable contact and the static contact, control the electromagnetic component to adjust the generated magnetic field to reduce the electromagnetic driving force produced by the driving part based on the generated magnetic field in the opposite direction to the electric repulsion force, so that the movable contact is not closed with the static contact again.

### CROSS-REFERENCE TO RELATED APPLICATION(S)

This application claims priority to Chinese Patent Application No. 202311309732.4 filed on Oct. 10, 2023, the contents of which are incorporated herein by reference in their entirety.

### TECHNICAL FIELD

The present disclosure relates to an electrical device, and in particular to a contactor.

### BACKGROUND

As a low-voltage control electrical device, the contactor may frequently connect and disconnect the main circuit and the large-capacity control circuit at a long distance, and has the characteristics of low cost and convenient production. Therefore, the contactor is widely used in industrial production, transportation, modern agriculture and human's daily life, etc.

Since the contactor needs to be frequently operated during service, it is required to have a long service life. Mechanical life and electrical life are two main performance indicators of the contactor. Mechanical life refers to the number of no-load operation cycles that the AC contactor can withstand without repair or replacement of any parts. Mechanical life mainly depends on the mechanical strength of the contactor parts and the firmness of the mechanical structure. Electrical life, which is also called electrical durability, refers to the number of connections and disconnections with load of the contactor before the contact fails under the specified connection and disconnection conditions. Usually, the mechanical life of the contactor is much higher than the electrical life thereof. When normal current flow through the contacts, the electric repulsion force between the contacts is not very large, so the movable contact and the static contact may still remain closed. When a short-circuit current flows between the contacts, the electric repulsion force between the contacts is large, causing the contacts to separate under the effect of the electric repulsion force. Therefore, an arc may appear between the contacts, and the arc may cause the contacts to melt. When the contacts are closed again, the melted contacts may weld, that is, the movable contact and the static contact are welded together.

### SUMMARY

The present disclosure provides a contactor, including: an electromagnetic component configured to generate a magnetic field, a static contact, a movable component including a connected movable contact, a first elastic part and a driving part, wherein the movable contact is configured to be operably closed with the static contact, the first elastic part is configured to generate an elastic force supporting the movable component, the driving part is configured to produce an electromagnetic driving force through the magnetic field generated by the electromagnetic component, a sensor configured to detect the displacement of the driving part based on the electric repulsion force generated by the current flowing through the movable contact and the static contact when the movable contact and the static contact are closed, and a controller configured to: control the movable contact of the movable component and the static contact to be closed, in response to the sensor detecting that the driving part is displaced based on the electric repulsion force generated by the current flowing through the movable contact and the static contact, control the electromagnetic component to adjust the generated magnetic field, to reduce the electromagnetic driving force produced by the driving part based on the generated magnetic field and in the opposite direction to the electric repulsion force.

According to the contactor of the present disclosure, wherein the elastic force is opposite to the electromagnetic driving force.

According to the contactor disclosed in the present disclosure, the electric repulsion force acts on the movable component, and the direction of the electric repulsion force is opposite to the direction from the movable contact to the static contact, and the electric repulsion force includes the Lorentz force and the Holm force.

According to the contactor disclosed in the present disclosure, the magnitude of the electric repulsion force depends on the shape of the current path of the current, and the shapes of the movable contact and the static contact.

According to the contactor disclosed in the present disclosure, when the controller controls the electromagnetic component not to generate a magnetic field, the elastic force generated by the first elastic part disconnects the movable contact from the static contact, and, wherein the situation where the movable contact of the movable component and the static contact are closed includes: controlling the electromagnetic component to generate a magnetic field, wherein the driving part produces an electromagnetic driving force through the magnetic field generated by the electromagnetic component, the driving part moves at least a first stroke under the drive of the electromagnetic driving force, and after the driving part moves the first stroke, the movable contact of the movable component and the static contact are closed.

According to the contactor disclosed in the present disclosure, the electromagnetic component and the driving part are configured such that when a normal current flows through the closed static contact and movable contact, the driving part is not displace based at least on the produced electric repulsion force and the electromagnetic driving force, and when a short-circuit current flows through the closed static contact and movable contact, the driving part is displaced based at least on the produced electric repulsion force and the electromagnetic driving force.

According to the contactor disclosed in the present disclosure, the electromagnetic component includes an iron core and a winding around the iron core, wherein controlling the electromagnetic component to generate a magnetic field includes controlling the control current flowing through the winding to control the electromagnetic component to generate a magnetic field, the driving part includes an armature, and wherein the electromagnetic component is configured by changing the material and shape of the iron core and the number of turns and shape of the winding, and the driving part is configured by changing the material and shape of the armature, such that when a normal current flows through the closed static contact and movable contact, the driving part is not displace based at least on the produced electric repulsion force and the electromagnetic driving force, and when a short-circuit current flows through the closed static contact and movable contact, the driving part is displaced based at least on the produced electric repulsion force and the electromagnetic driving force.

According to the contactor disclosed in the present disclosure, the contactor includes a permanent magnet contactor.

According to the contactor disclosed in the present disclosure, the electromagnetic component includes an iron core and a winding around the iron core, wherein controlling the electromagnetic component to generate a magnetic field includes controlling a control current flowing through the winding to control the electromagnetic component to generate a magnetic field, the driving part includes an armature, and wherein the controller is configured to control the control current flowing through the winding so that when a normal current flows through the closed static contact and movable contact, the driving part is not displace based at least on the produced electric repulsion force and the electromagnetic driving force, and when a short-circuit current flows through the closed static contact and movable contact, the driving part is displaced based at least on the produced electric repulsion force and the electromagnetic driving force.

According to the contactor disclosed in the present disclosure, the movable component includes a second elastic part, wherein the second elastic part is configured to provide a pressure in a direction toward the static contact when the movable contact and the static contact are closed, and wherein the driving part is displaced based on the electric repulsion force generated by the current flowing through the movable contact and the static contact, and then the movable contact is displaced the driving part after the second elastic part is actuated based on the electric repulsion force.

According to the contactor disclosed in the present disclosure, in response to the sensor detecting that the electric repulsion force generated by the driving part based on the current flowing through the movable contact and the static contact is displaced, controlling the electromagnetic component to adjust the generated magnetic field includes: in response to the sensor detecting that the displacement of the electric repulsion force generated by the driving part based on the current flowing through the movable contact and the static contact is greater than the second stroke, controlling the electromagnetic component to adjust the generated magnetic field.

According to the contactor disclosed in the present disclosure, wherein the second stroke is at least 85% of the first stroke.

According to the contactor disclosed in the present disclosure, wherein the electromagnetic component is controlled to adjust the generated magnetic field to reduce the electromagnetic driving force produced by the driving part based on the generated magnetic field in the opposite direction to the electric repulsion force includes: controlling the electromagnetic component not to generate a magnetic field to reduce the electromagnetic driving force of the driving part to zero, so that the movable contact and the static contact are not closed again.

According to the contactor disclosed in the present disclosure, in which the contactor is a main loop AC contactor, in which the static contacts include at least three static contacts corresponding to the three-phase current, and the movable contacts include at least three movable contacts respectively configured in pairs with the three static contacts, and the three movable contacts are configured to be operably closed with the three static contacts respectively.

According to the contactor of the present disclosure, the electric repulsion force produced on the closed static contact and movable contact corresponding to two phases of the three-phase current is greater than the electric repulsion force produced on the closed static contact and movable contact corresponding to the other phase of the three-phase current.

According to the contactor of the present disclosure, the contactor is a main loop DC contactor.

According to the contactor of the present disclosure, the short-circuit current is at least 10,000 amperes.

According to the contactor of the present disclosure, the sensor is a current sensor, and the current sensor is configured to detect the displacement of the driving part based on the electric repulsion force generated by the current flowing through the movable contact and the static contact by determining the change in control current caused by the change in the positional relationship between the driving part and the electromagnetic component when the driving part is displaced, wherein the controller is configured to control the electromagnetic component to adjust the generated magnetic field in response to the change in control current detected by the current sensor.

According to the contactor of the present disclosure, the contactor includes a normally closed contactor.

The present disclosure provides a method for controlling a contactor, comprising: controlling the movable contact of a movable component and the static contact to be closed by a controller, wherein the movable component comprises a connected movable contact, a first elastic part and a driving part, wherein the movable contact is configured to be operably closed with the static contact, the first elastic part is configured to generate an elastic force to support the movable component, the driving part is configured to produce an electromagnetic driving force through a magnetic field generated by an electromagnetic component, in response to a sensor detecting that the driving part is displaced by an electric repulsion force generated by a current flowing through the movable contact and the static contact, the controller controls the electromagnetic component to adjust the generated magnetic field to reduce the electromagnetic driving force produced by the driving part according to the generated magnetic field in the opposite direction to the electric repulsion force, so that the movable contact is not closed with the static contact again.

According to the contactor of the present disclosure, when the normal current of the main loop flows through the contactor, the movable contact and the static contact are closed. When the short-circuit current of the main loop flows through the contactor, the movable contact and the static contact are disconnected due to the electric repulsion force and melted due to the arc. When it is detected that the movable contact and the static contact are disconnected due to the electric repulsion force caused by the short-circuit current, the electromagnetic force opposite to the direction of the electric repulsion force is reduced, so that the movable contact and the static contact cannot be closed again, preventing the movable contact and the static contact from being welded, thereby avoiding contactor failure and improving equipment reliability. The mechanism for preventing contact welding during short circuit according to the present disclosure may be applied to contactors of various shapes and various types or structures of main loop current paths, so it has good flexibility.

### BRIEF DESCRIPTION OF DRAWINGS

The above and other aspects, features and advantages of the specific embodiments of the present disclosure will become apparent from the following description in combination with the drawings, in which:

FIG. 1 illustrates a contactor.

FIG. 2A is a schematic diagram of the Lorentz force in the contactor,

FIG. 2B is a schematic diagram of the Holm force in the contactor,

FIG. 3A illustrates a contactor in which the movable contact and the static contact are in a closed state according to an embodiment of the present disclosure,

FIG. 3B is a schematic diagram of the short-circuit current path of the main loop current of the contactor according to an embodiment of the present disclosure,

FIG. 3C illustrates a contactor in which the movable contact and the static contact are in an open state according to an embodiment of the present disclosure,

FIG. 4 is a flow chart of the control method of the contactor according to the present disclosure.

### DETAILED DESCRIPTION

Before proceeding to the following detailed description, it may be advantageous to set forth the definitions of certain words and phrases used throughout this disclosure. The terms “include” and “comprises” and their derivatives mean including but not limited to. The term “controller” or “control unit” refers to any device, system, or part thereof that controls at least one operation. Such a controller may be implemented with hardware, or a combination of hardware and software and/or firmware. For example, a controller may include, for example, an application specific integrated circuit (ASIC), a general or dedicated central processing unit (CPU), a digital signal processor (DSP), and a programmable logic device, such as a field programmable gate array (FPGA). The controller may be manufactured as a single printed circuit board (PCB) or distributed on several interconnected PCBs. The controller may contain other processing circuits, for example, a controller may include two processing circuits such as an FPGA and a CPU interconnected on a PCB. The functions associated with any particular controller may be centralized or distributed, whether local or remote. The phrase “at least one”, when used with a list of items, means that different combinations of one or more of the listed items may be used, and only one item in the list may be required. For example, “at least one of A, B, C” includes any of the following combinations: A, B, C, A and B, A and C, B and C, A and B and C.

Definitions of other specific words and phrases are provided throughout this disclosure. It should be understood by a person of ordinary skill in the art that such definitions apply to prior and future uses of such defined words and phrases in many, if not most, cases.

The various embodiments of the principles of the present disclosure described below in conjunction with the accompanying drawings are for illustration only and should not be interpreted in any way as limiting the scope of the present disclosure. It will be understood by those skilled in the art that the principles of the present disclosure may be implemented in any appropriately arranged system or device. In some cases, the actions described in the present disclosure may be performed in a different order and still achieve the desired results. In addition, the processes depicted in the drawings do not necessarily require the specific order shown or sequential order to achieve the desired results. In certain implement, multitasking and parallel processing may be advantageous.

The text and drawings are provided only as examples to assist in understanding the present disclosure. They should not be interpreted as limiting the scope of the claims appended to the present disclosure in any way. Although certain embodiments and examples have been provided, it is clear to those skilled in the art based on the content of the present disclosure that the embodiments and examples shown may be changed without departing from the scope of the present disclosure.

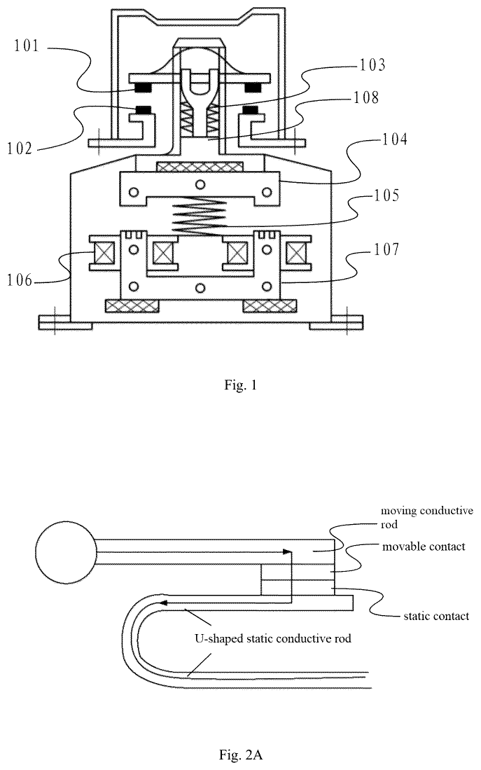

FIG. 1 illustrates a contactor. The contactor shown in FIG. 1 is an electromagnetic contactor.

As shown in FIG. 1, the contactor of FIG. 1 may include a movable contact 101, a static contact 102, a movable contact elastic part 103, a driving part 104, a main elastic part 105, a winding 106, an iron core 107, and a connecting part 108.

The movable contact 101 may be configured to be operably closed with the static contact 102 to conduct the current flowing through the main loop. The materials forming the movable contact 101 and the static contact 102 may include, but are not limited to, silver, silver alloy, tungsten, tungsten alloy, copper alloy such as copper-cobalt alloy, and the like. The shapes of the movable contact 101 and the static contact 102 may include point shape, sheet shape, spherical shape, pile shape, and the like.

The movable contact elastic part 103 may provide the movable contact 101 with pressure in the direction toward the static contact 102 when the movable contact 101 and the static contact 102 are closed, so that the movable contact 101 and the static contact 102 are closed more reliably. The movable contact elastic part 103 may include an elastic part such as a spring.

A control current may flow through the winding 106. When the control current flows through the winding, the winding 106 may produce a magnetic field in the iron core 107. The winding 106 and the iron core 107 may be collectively referred to as an electromagnetic component.

The driving part 104 may produce an electromagnetic driving force according to the magnetic field generated by the winding 106 and the iron core 107, and drive the movable component including the movable contact 101, the connecting part 108 and the driving part 104 to move through the electromagnetic driving force. For example, the movable component may be driven to move toward the winding 106 and the iron core 107, so that the movable contact 101 and the static contact 102 are closed. The driving part 104 may be, for example, an armature, etc.

The main elastic part 105 may provide the movable component with a force in the opposite direction to the electromagnetic driving force generated by the electromagnetic component on the driving part 104. For example, when the electromagnetic component does not generate a magnetic field, the main elastic part 105 may provide an upward supporting force for the movable component so that the movable contact and the static contact are not closed. The main elastic part 105 may include an elastic part such as a spring.

When the normal current of the main loop flows through the closed static contact 102 and the movable contact 101, the static contact 102 and the movable contact 101 may remain closed. When a short-circuit current much larger than the normal current flows through the closed static contact 102 and the movable contact 101, the closed static contact 102 and the movable contact 101 may be disconnected due to the electric repulsion force produced by the short-circuit current. The electric repulsion force may include Lorentz force and Holm force. After disconnection, an arc may occur between the static contact 102 and the movable contact 101, and thus causing the static contact 102 and the movable contact 101 to melt. When the movable contact 101 falls back, the melted static contact 102 may be welded with the movable contact 101, resulting in failure or damage of the contactor. The Chinese national standard GB 14048.4 stipulates:

“Contactor and starter manufacturers should recommend an applicable short-circuit protection device (SCPD) and provide the relevant characteristics of this SCPD. The rated value of the recommended SCPD should be applicable to all given rated working currents, rated working voltages and respective usage categories.

There are two types of coordination (protection types):

“Type 1” coordination requires that the contactor or starter should not cause harm to human and device under short-circuit conditions, and it is allowed to stop continuing to be used before repairing and replacing parts;

“Type 2” coordination requires that the contactor or starter should not cause harm to human and device under short-circuit conditions, and should be able to continue to be used. Contact welding is allowed, but the manufacturer should specify the method used for device maintenance.”

That is to say, in the Chinese national standard, when a short-circuit current flows through the contactor, it is allowed to stop using the contactor before repairing and replacing parts, or it is allowed to continue to use the contactor but the manufacturer should specify the maintenance method under contact welding.

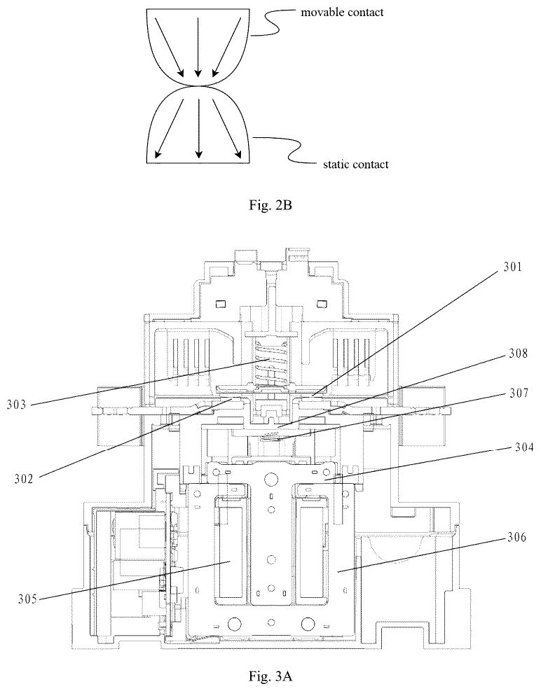

FIG. 2A is a schematic diagram of the Lorentz force in the contactor.

As shown in FIG. 2A, the current of the main loop flows through the moving conductive rod, the closed movable contact and the static contact, and the U-shaped static conductive rod. The direction of the current flowing through the moving conductive rod is opposite to that of the current flowing through the static conductive rod. Based on the basic principle of electromagnetic field, it can be known that mutually repelling electric repulsion force which is called as Lorentz force is produced between the opposite currents. The Lorentz force is mainly affected by the shape of the current path.

FIG. 2B is a schematic diagram of the Holm force in the contactor.

Because the closing surfaces of the movable contact and the static contact are not completely flat, when the movable contact and the static contact are closed, the actual closing area is a few conductive spots of the movable contact and the static contact. When the current of the main loop flows through the conductive spots, the current line shrinks. According to the basic principle of electromagnetic field, the shrinking current line will produce electric repulsion force which is called as Holm force on the movable contact and the static contact. Holm force is mainly affected by the shape of the contact.

When a large short-circuit current flows through the closed movable contact and the static contact, the electric repulsion force including the Lorentz force and the Holm force may be very large.

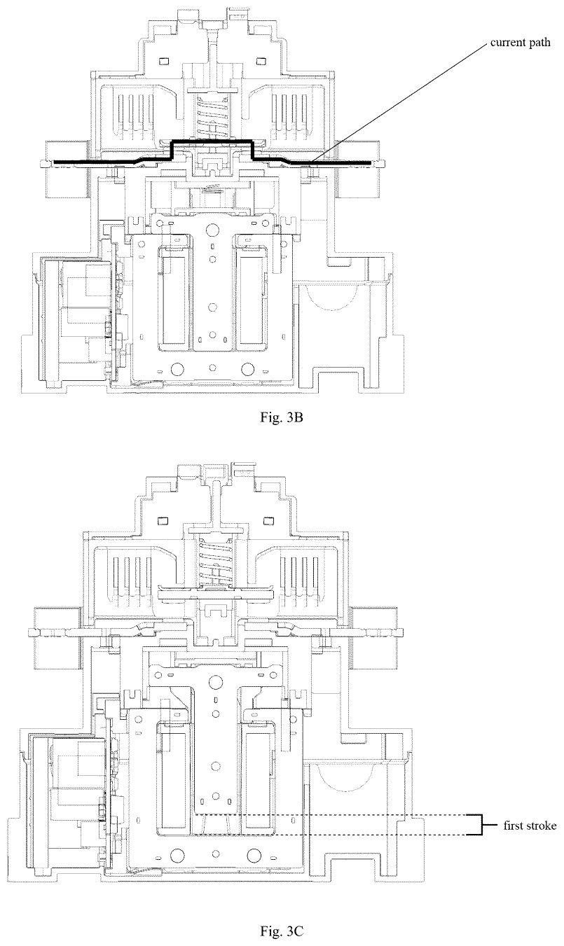

FIG. 3A illustrates a contactor in which the movable contact and the static contact are in a closed state according to an embodiment of the present disclosure. FIG. 3B is a schematic diagram of the short-circuit current path of the main loop current of the contactor according to an embodiment of the present disclosure. FIG. 3C illustrates a contactor in which the movable contact and the static contact are in an open state according to an embodiment of the present disclosure. The contactors shown in FIGS. 3A-3C are an electromagnetic contactors.

The contactor shown in FIG. 3A may include a static contact 302, a movable component, an electromagnetic component, a controller (not shown) and a sensor (not shown). The movable contact 301 and the static contact 302 of the contactor in FIG. 3A are in a closed state.

The electromagnetic component may include a winding 305 and an iron core 306. The electromagnetic component may be configured to generate a magnetic field. Specifically, a control current may flow through the winding 305. When the control current flows through the winding, the winding 305 may generate a magnetic field in the iron core 306.

The movable component may include a connected movable contact 301, a driving part 304 and a first elastic part 307. The description of the movable contact 301, the static contact 302, and the driving part 304 may be similar to the description of the movable contact 101, the static contact 102, and the driving part 104 in FIG. 1. The movable contact 301 may be configured to be operably closed with the static contact. The first elastic part 307 may be configured to generate an elastic force supporting the movement of the movable component. The first elastic part 307 may include an elastic part such as a spring, etc. The driving part 304 may be configured to produce an electromagnetic driving force through a magnetic field generated by an electromagnetic component. For example, the direction of the electromagnetic driving force is opposite to the direction of the elastic force. In one embodiment, the movable component may further include a connecting part 308, which connects the movable contact 301, the first elastic part 307, and the driving part 304 to form a movable component. Alternatively, the movable contact 301, the first elastic part 307, and the driving part 304 of the movable component may be connected together to form a movable component without the connecting component 308.

The sensor may be configured to detect the displacement of the driving part 304 which occurs based on the electric repulsion force generated by the main loop current flowing through the movable contact and the static contact in the case that the movable contact and the static contact are closed. The path of the main loop short-circuit current flowing through the contactor is shown in FIG. 3B, but this is only schematic. As can be seen from the description with reference to FIG. 2A and FIG. 2B, the main loop short-circuit current flowing through the movable contact and the static contact may generate an electric repulsion force, which may be large enough to cause the driving part 304 of the movable component to be displaced due to the electric repulsion force.

The controller may be configured to control the movable contact 301 of the movable component and the static contact 302 to be closed, and in response to the sensor detecting that the movable component is displaced based on the electric repulsion force generated by the current flowing through the closed movable contact 301 and the static contact 302, control the electromagnetic component to adjust the generated magnetic field, to reduce the electromagnetic driving force produced by the driving part according to the generated magnetic field in the opposite direction of the electric repulsion force. By reducing the electromagnetic driving force, the movable contact 301 may no longer fall back based on the elastic force of the first elastic part 307.

According to the contactor of the embodiment of the present disclosure, when a short circuit occurs in the main loop of the contactor, and the movable contact and the static contact are disconnected due to the electric repulsion force and melted due to the arc, the controller may control the movable contact not to fall back to the static contact, so that the movable contact and the static contact do not weld, and thus avoiding the damage to the movable contact and the static contact, and ensuring that the contactor can still maintain its function after the short circuit. Since the welding of the movable contact and the static contact does not occur in the contactor according to the embodiment of the present disclosure, the performance of the contactor is higher than the relevant provisions in the Chinese national standard GB 14048.4, and can meet both the “Type 1” coordination and “Type 2” coordination in GB 14048.4.

In one embodiment, when the controller controls the electromagnetic component not to generate a magnetic field, the elastic force generated by the first elastic part 307 may disconnect the movable contact 302 from the static contact 301, as shown in FIG. 3C.

According to the contactor of FIGS. 3A-3C, when the user expects to connect the main loop through the contactor, the controller may control the electromagnetic component to generate a magnetic field. The driving part 304 produces an electromagnetic driving force through the magnetic field generated by the electromagnetic component. The driving part 304 moves at least a first stroke under the drive of the electromagnetic driving force. After the driving part 304 moves the first stroke, the movable contact of the movable component and the static contact are reliably closed, as shown in FIG. 3A.

When a normal current flows through the closed static contact 301 and the movable contact 304, the driving part 304 is not displaced based at least on the produced electric repulsion force and the electromagnetic driving force. When a short-circuit current flows through the closed static contact and movable contact, the driving part 304 is displaced based at least on the produced electric repulsion force and the electromagnetic driving force. For example, the short-circuit current may be at least 10,000 amperes, and those skilled in the art should understand that, according to the design results of the electric repulsion force and electromagnetic force, and considering the respective minimum non-melting welding short-circuit current threshold under different current frames, other short-circuit currents are also possible. For example, when the short-circuit current flows through the closed static contact and movable contact, a large electric repulsion force acting on the movable component may be generated, which is sufficient to disconnect the movable contact from the static contact, thereby displacing the driving part 304 according to the embodiment of the present disclosure. When the movable contact 301 and the static contact 302 are disconnected due to the electric repulsion force, an arc that may melt the movable and static contacts is produced between the movable contact 301 and the static contact 302. When the sensor detects that the driving part 304 is displaced due to the electric repulsion force generated by the short-circuit current, the controller may control the electromagnetic component to adjust the generated magnetic field, for example, the electromagnetic component may be controlled to reduce the generated magnetic field, thereby reducing the electromagnetic driving force on the driving part. For example, the electromagnetic component may be controlled not to generate a magnetic field to reduce the electromagnetic driving force of the driving part to zero. Thus, the force acting on the driving part in the same direction as the electric repulsion force (for example, the electric repulsion force itself, the elastic force of the first elastic part 307, etc.) is greater than the force in the opposite direction to the electric repulsion force (for example, the electromagnetic driving force, gravity, etc.). In order not to obscure the present disclosure, the specific force analysis is not described in detail here. As shown in FIG. 3C, in this way, for example, the driving part 304 may move upward and return to the first stroke, so that the melted movable contact 301 no longer falls back based on the elastic force of the first elastic part 307, or the driving part 304 may move upward and return to a stroke less than the first stroke, but still enable the melted movable contact 301 to no longer fall back based on the electromagnetic driving force and the elastic force of the first elastic part 307. Therefore, the melted movable contact 301 and the static contact 302 are not welded.

In one embodiment, when the controller determines through a sensor that the driving part 304 has any displacement due to the electric repulsion force generated by the main loop current, the controller may control the electromagnetic component to adjust the generated magnetic field. In another embodiment, in response to the sensor detecting that the displacement of the driving part 304 based on the electric repulsion force generated by the current flowing through the movable contact and the static contact is greater than the second stroke, the electromagnetic component may be controlled to adjust the generated magnetic field. For example, the second stroke may be at least 85% of the first stroke. In this way, the incorrect operation of the contactor electromagnetic component with respect to adjusting the magnetic field may be reduced, thereby improving the reliability of the contactor.

Different electromagnetic driving forces may be configured to cooperate with contactors of different structures (for example, contactors with various main loop current paths and various contact shapes). For example, different driving parts, electromagnetic components, and control currents flowing through the electromagnetic components may be configured to cooperate with contactors of different structures, and thus preventing welding during short circuits.

In one embodiment, the electromagnetic component or the driving part may be configured so that the electromagnetic component and the driving part match the contacts of various shapes and the contactors of the main loop current path, so that when the normal current flows through the closed static contact 302 and the movable contact 301, the driving part 304 is not displaced based at least on the produced electric repulsion force and the electromagnetic driving force. When the short-circuit current flows through the closed static contact and movable contact, the driving part 304 is displaced based at least on the produced electric repulsion force and the electromagnetic driving force. For example, the electromagnetic component may be configured by changing the material and shape of the iron core 306 and the number of turns and shape of the winding 305. For example, the driving part may be configured by changing the material and shape of the armature.

In one embodiment, the control current flowing through the electromagnetic component may be configured to match the contactors of various shapes of contacts and the main loop current path, so that when the normal current flows through the closed static contact 301 and the movable contact 302, the driving part 304 is not displaced based at least on the produced electric repulsion force and the electromagnetic driving force. When the short-circuit current flows through the closed static contact and movable contact, the driving part 304 is displaced based at least on the produced electric repulsion force and the electromagnetic driving force.

In one embodiment, the contactor shown in FIGS. 3A-3C may also include a second elastic part 303. The second elastic part 303 is configured to provide pressure to the movable contact 301 in the direction toward the static contact when the movable contact 301 and the static contact 302 are closed, so that the movable contact 301 and the static contact 302 are closed more reliably. When a short-circuit current flows through the closed movable contact 301 and the static contact 302, the movable contact 301 actuates the second elastic part 301 based on the electric repulsion force, and after the second elastic part 303 is actuated, the driving part 304 is displaced. The second elastic part 303 may be an elastic part such as a spring. In addition, when the second elastic part 303 provides pressure to the movable contact 301 to make the movable contact 301 and the static contact 302 more reliably closed, the second elastic part 303 may be in a compressed state. However, those skilled in the art should understand that by configuring the second elastic part 303 at different positions, the second elastic part 303 may provide pressure to the movable contact 301 to make the closure reliable when it is in a stretched state.

The contactor shown in FIGS. 3A-3C may be an AC contactor. The AC contactor may include at least three static contacts 302 corresponding to the three-phase current. And the AC contactor may include at least three movable contacts 301 configured in pairs with the three static contacts 302, respectively. The three movable contacts 301 are configured to be operably closed with the three static contacts 302, respectively. In this way, the three-phase AC current of the main loop may flow through the contactor through three pairs of contacts, respectively. The three pairs of contacts may correspond to one driving part and one electromagnetic component. When a short-circuit current flows through the contact pair, the electric repulsion force produced on the closed static contacts 302 and the movable contacts 301 corresponding to two phases of the three-phase current may be greater than the electric repulsion force produced on the closed static contacts 302 and the movable contacts 301 corresponding to the other phase of the three-phase current. By analyzing the electric repulsion force on the three pairs of contacts through which the three-phase current flows, or mainly analyzing the larger electric repulsion force on two pairs of contacts, different driving parts, electromagnetic components, and control currents flowing through the electromagnetic components may be configured to cooperate with contactors of different structures (for example, contactors with different main loop current path shapes and different contact shapes), so as to avoid the melting of the contacts from welding during short circuit. Those skilled in the art should understand that, according to the use scenario of the contactor, more pairs of contacts may be configured for the contactor, and by analyzing the electric repulsion force of the contacts, different electromagnetic driving forces may be configured for cooperation, for example, by configuring different driving parts, electromagnetic components, and control currents flowing through the electromagnetic components for cooperation. The contactor shown in FIGS. 3A-3C may also be a DC contactor. The DC contactor may include a pair of contacts corresponding to a single polarity, or two pairs of contacts corresponding to a bipolarity, etc. By analyzing the electric repulsion force of the contacts of the DC contactor, different driving parts, electromagnetic components, and control currents flowing through the electromagnetic components may be configured for cooperation.

In one embodiment, the sensor may be any sensor capable of directly or indirectly detecting the movement of the driving part 304, such as a current sensor, a position sensor, an inertial sensor, a proximity sensor, etc., but the present disclosure is not limited thereto. For example, the current sensor may be configured to detect the displacement of the driving part based on the electric repulsion force generated by the current flowing through the movable contact and the static contact by determining the change in the control current caused by the change in the positional relationship between the driving part and the electromagnetic component when the driving part 304 is displaced due to the electric repulsion force. And the controller may be configured to control the electromagnetic component to adjust the generated magnetic field in response to the change in the control current such as in the winding 305, detected by the current sensor.

Although the above-mentioned contactor according to the embodiment of the present disclosure is shown, it can be understood by those skilled in the art that the technicians who benefit from the present disclosure may apply the contact welding prevention mechanism of the present disclosure to various combinations of various contactors including electromagnetic contactors/permanent magnet contactors, AC contactors/DC contactors, normally open contactors/normally closed contactors, etc., as well as various other types of contactors.

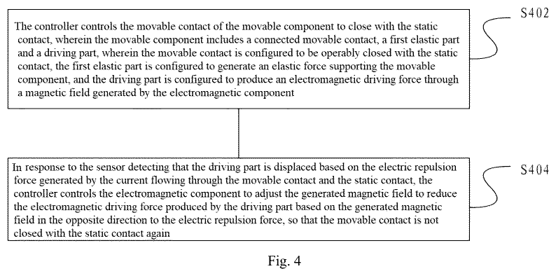

FIG. 4 is a flow chart of a control method of a contactor according to the present disclosure.

In S402, the controller controls the movable contact of the movable component to close with the static contact, wherein the movable component includes a connected movable contact, a first elastic part and a driving part, wherein the movable contact is configured to be operably closed with the static contact, the first elastic part is configured to generate an elastic force supporting the movable component, and the driving part is configured to produce an electromagnetic driving force through a magnetic field generated by the electromagnetic component.

For example, a relationship may be established between the electromagnetic driving force produced by the magnetic field generated by the electromagnetic component and the electric repulsion force produced by the movable contact, so as to ensure that after a short-circuit current exceeding a certain threshold occurs and flows through the movable contact, the driving part may be displaced under the electric repulsion force and the electromagnetic driving force.

In S404, in response to the sensor detecting that the driving part is displaced based on the electric repulsion force generated by the current flowing through the movable contact and the static contact, the controller controls the electromagnetic component to adjust the generated magnetic field to reduce the electromagnetic driving force produced by the driving part based on the generated magnetic field in the opposite direction to the electric repulsion force, so that the movable contact is not closed with the static contact again.

Although the present disclosure has been described with exemplary embodiments, various changes and modifications may be suggested to those skilled in the art. The present disclosure is intended to cover such changes and modifications that fall within the scope of the appended claims.

Any description in the present disclosure should not be construed as implying that any particular element, step, or function is an essential element that must be included in the claims scope. The scope of the patented subject matter is limited solely by the claims.

What is claimed is:

1. A contactor, comprising:
an electromagnetic component configured to generate a magnetic field,
a static contact,
a movable component comprising a connected movable contact, a first elastic part and a driving part, wherein the movable contact is configured to be operably close with the static contact, the first elastic part is configured to generate an elastic force supporting the movable component, the driving part is configured to produce an electromagnetic driving force through the magnetic field generated by the electromagnetic component,
a sensor configured to detect the displacement of the driving part based on the electric repulsion force generated by the current flowing through the movable contact and the static contact in the case that the movable contact and the static contact are closed, and
a controller configured to:
control the movable contact of the movable component and the static contact to be closed, in response to the sensor detecting that the driving part is displaced based on the electric repulsion force generated by the current flowing through the movable contact and the static contact, control the electromagnetic component to adjust the generated magnetic field, to reduce the electromagnetic driving force produced by the driving part according to the generated magnetic field in the opposite direction to the electric repulsion force, so that the movable contact is not closed with the static contact again.

2. The contactor of claim 1, wherein the elastic force is in the opposite direction to the electromagnetic driving force.

3. The contactor of claim 1, wherein the electric repulsion force acts on the movable component, and the direction of the electric repulsion force is opposite to the direction from the movable contact to the static contact, and the electric repulsion force includes a Lorentz force and a Holm force.

4. The contactor of claim 3, wherein the magnitude of the electric repulsion force depends on the shape of the current path of the current, and the shapes of the movable contact and the static contact.

5. The contactor of claim 1, wherein when the controller controls the electromagnetic component not to generate a magnetic field, the elastic force generated by the first elastic part disconnects the movable contact from the static contact, and
wherein controlling the movable contact of the movable component and the static contact to be closed comprises:
controlling the electromagnetic component to generate a magnetic field, wherein the driving part produces an electromagnetic driving force through the magnetic field generated by the electromagnetic component,
the driving part moves at least a first stroke under the drive of the electromagnetic driving force, and after the driving part moves the first stroke, the movable contact of the movable component and the static contact are closed.

6. The contactor of claim 5, wherein the electromagnetic component and the driving part are configured to, when a normal current flows through the closed static contact and movable contact, the driving part is not displace based at least on the produced electric repulsion force and the electromagnetic driving force, and when a short-circuit current flows through the closed static contact and movable contact, the driving part is displaced based at least on the produced electric repulsion force and the electromagnetic driving force.

7. The contactor of claim 6, wherein the electromagnetic component comprises an iron core and a winding around the iron core, wherein controlling the electromagnetic component to generate a magnetic field comprises controlling the control current flowing through the winding to control the electromagnetic component to generate a magnetic field, the driving part comprises an armature, and,
wherein the electromagnetic component is configured by changing the material and shape of the iron core and the number of turns and shape of the winding, and the driving part is configured by changing the material and shape of the armature, such that when a normal current flows through the closed static contact and movable contact, the driving part is not displace based at least on the produced electric repulsion force and the electromagnetic driving force, and when a short-circuit current flows through the closed static contact and movable contact, the driving part is displaced based at least on the produced electric repulsion force and the electromagnetic driving force.

8. The contactor of claim 1, wherein the contactor comprises a permanent magnet contactor.

9. The contactor of claim 5, wherein the electromagnetic component comprises an iron core and a winding around the iron core, wherein controlling the electromagnetic component to generate a magnetic field comprises controlling a control current flowing through the winding to control the electromagnetic component to generate a magnetic field, the driving part comprises an armature, and wherein the controller is configured to control the control current flowing through the winding so that when a normal current flows through the closed static contact and movable contact, the driving part is not displace based at least on the produced electric repulsion force and the electromagnetic driving force, and when a short-circuit current flows through the closed static contact and movable contact, the driving part is displaced based at least on the produced electric repulsion force and the electromagnetic driving force.

10. The contactor of claim 1, wherein the movable component includes a second elastic part, wherein the second elastic part is configured to provide a pressure for the movable contact in a direction toward the static contact when the movable contact and the static contact are closed, and,
wherein that the driving part is displaced based on the electric repulsion force generated by the current flowing through the movable contact and the static contact includes, after the movable contact causes the second elastic part to actuate based on the electric repulsion force, the driving part is displaced.

11. The contactor of claim 5, wherein, in response to the sensor detecting that the driving part is displaced based on the electric repulsion force generated by the current flowing through the movable contact and the static contact, controlling the electromagnetic component to adjust the generated magnetic field includes:
in response to the sensor detecting that the displacement of the driving part based on the electric repulsion force generated by the current flowing through the movable contact and the static contact is greater than the second stroke, controlling the electromagnetic component to adjust the generated magnetic field.

12. The contactor of claim 11, wherein the second stroke is at least 85% of the first stroke.

13. The contactor of claim 1, wherein controlling the electromagnetic component to adjust the produced magnetic field to reduce the electromagnetic driving force produced by the driving part according to the generated magnetic field and in the opposite direction to the electric repulsion force comprises:
controlling the electromagnetic component not to generate a magnetic field to reduce the electromagnetic driving force of the driving part to zero, so that the movable contact is not closed with the static contact again.

14. The contactor of claim 5, wherein the contactor is a main loop AC contactor, wherein the static contact includes at least three static contacts corresponding to the three-phase current, and the movable contact includes at least three movable contacts respectively configured in pairs with the three static contacts, and the three movable contacts are configured to be operably closed with the three static contacts respectively.

15. The contactor of claim 14, wherein the electric repulsion force produced on the closed static contact and movable contact corresponding to two phases of the three-phase current is greater than the electric repulsion force produced on the closed static contact and movable contact corresponding to the other phase of the three-phase current.

16. The contactor of claim 5, wherein the contactor is a main loop DC contactor.

17. The contactor of claim 6, wherein the short-circuit current is at least 10,000 amperes.

18. The contactor of claim 7, wherein the sensor comprises a current sensor configured to detect the displacement of the driving part due to the electric repulsion force generated by the current flowing through the movable contact and the static contact by determining the change in control current caused by the change in the positional relationship between the driving part and the electromagnetic component when the driving part is displaced,
wherein the controller is configured to control the electromagnetic component to adjust the generated magnetic field in response to the change in control current detected by the current sensor.

19. The contactor of claim 1, wherein the contactor comprises a normally closed contactor.

20. A method for controlling a contactor, comprising:
controlling the movable contact of a movable component and the static contact to be closed by a controller,
wherein, the movable component comprises a connected movable contact, a first elastic part and a driving part, wherein the movable contact is configured to be operably closed with the static contact, the first elastic part is configured to generate an elastic force to support the movable component, and the driving part is configured to produce an electromagnetic driving force through a magnetic field generated by an electromagnetic component,
in response to a sensor detecting that the driving part is displaced by an electric repulsion force generated by a current flowing through the movable contact and the static contact, the controller controls the electromagnetic component to adjust the generated magnetic field to reduce the electromagnetic driving force produced by the driving part according to the generated magnetic field in the opposite direction to the electric repulsion force, so that the movable contact is not closed with the static contact again.
